(19) United States
(12) Patent Application Publication
(10) Pub. No.: US 2024/0417296 A1
(43) Pub. Date: Dec. 19, 2024

(54) ANAEROBIC BIOREACTOR WITH ELECTROLYTIC REGENERATION FOR WASTEWATER TREATMENT

(71) Applicant: South Dakota Board of Regents, Pierre, SD (US)

(72) Inventors: Maryam Amouamouha, Rapid City, SD (US); Travis W. Walker, Rapid City, SD (US)

(73) Assignee: South Dakota Board of Regents, Pierre, SD (US)

(21) Appl. No.: 18/706,315

(22) PCT Filed: Nov. 3, 2022
(86) PCT No.: PCT/US22/79248

§ 371 Date: Apr. 30, 2024

Related U.S. Application Data
(60) Provisional application No. 63/275,089, filed on Nov. 3, 2021.

(51) Int. Cl. C02F 3/00; C02F 1/44; C02F 1/461; C02F 1/66; C02F 3/28

(52) U.S. Cl. CPC C02F 3/006; C02F 1/442; C02F 1/46104; C02F 1/66; C02F 3/284; C02F 3/2853; C02F 2201/46135; C02F 2203/006; C02F 2209/02; C02F 2209/06; C02F 2209/10

(57) ABSTRACT

An anaerobic bioreactor with electrolytic regeneration system, method and apparatus for monitoring pH levels which is simultaneously efficient in both anaerobic digestion and optimized filtration process is disclosed. To maintain the pH stability of an anaerobic bioreactor, an electrolysis process is integrated with the bioreactor. The integration of an electrolysis process with the bioreactor sustains the pH in the optimized range for anaerobic process while enhancing the removal of contaminants in the bioreactor, augmenting biogas production, and mitigating fouling.

### CROSS-REFERENCE TO RELATED APPLICATIONS

This application claims priority under 35 U.S.C. § 119 to provisional application Ser. No. 63/275,089 filed Nov. 3, 2021 which is incorporated by reference in their entirety.

### FIELD OF THE INVENTION

The present disclosure relates to anaerobic bioreactors. More particularly, but not exclusively, the present disclosure relates to an anaerobic membrane bioreactor with electrolytic regeneration (AMBER) or an electrolytic anaerobic baffled reactor (EABR) for wastewater treatment.

### BACKGROUND

The constant release of different kinds of wastewater (residential, industrial, and agricultural) into the environment has significantly impacted the freshwater resources worldwide. Innovative recycling technologies using biological, chemical, and physical systems (or some combination) have been introduced with the aim of protecting humans, wildlife, and the environment. Adequate wastewater treatment prior to its discharge into the environment is essential to reduce health issues and environmental effects that are related to wastewater release. Therefore, what is needed is a system that enhances wastewater treatment efficiency and effluent quality while decreasing the dependency of a plant on chemical applications to maintain the treatment environment. An anaerobic membrane bioreactor with electrolytic regeneration (AMBER) and an electrolytic anaerobic baffled reactor (EABR) were developed and combine two or three technologies (biodegradation, electrolysis with optimized electrolytic regeneration, and membrane separation).

### SUMMARY

In at least one aspect of the present disclosure, an anaerobic bioreactor or an anaerobic membrane bioreactor with electrolytic regeneration for wastewater treatment is disclosed. The anaerobic bioreactor may include an anaerobic bioreactor having an inner wall. The inner wall may divide the bioreactor into a plurality of chambers housing anaerobic bacteria. The anaerobic bioreactor may also include at least one pair of electrodes, the pair comprising an anode and a cathode. The pair of electrodes are configured to adjust the pH level of wastewater in the bioreactor. The anaerobic bioreactor may include a pH sensor for sensing the pH level of wastewater flowing through the bioreactor and a discharge mechanism for carrying effluent to a membrane cell. The anaerobic bioreactor system may also include a membrane cell comprising a nanocomposite membrane for filtering effluent produced by the anerobic bioreactor. The pair of electrodes may reduce an amount of flux discharged from the bioreactor to the membrane cell. The bioreactor may also include a pH control system configured to adjust the pH of the bioreactor if a pH level exceeds threshold.

In another aspect of the present disclosure, an anaerobic bioreactor control system is disclosed. The control system may control the pH level of an anerobic bioreactor. The control system may include the bioreactor. The bioreactor may house a pH sensor for monitoring the pH of wastewater flowing through the bioreactor and a plurality of microorganisms. The wastewater may include sludge which may be broken down by the plurality of microorganisms prior to reaching a membrane cell operatively connected to the bioreactor. The control system may also include the membrane cell for receiving the wastewater from the bioreactor and filtering the wastewater through a membrane housed within the membrane cell. The control system may also include a pH adjuster operatively connected to the bioreactor and a control system. The pH adjuster may be configured to adjust the pH if the pH exceeds a threshold. The control system may further include a processor. The control system may also analyze the pH of the bioreactor utilizing data sensed by the pH sensor, while the control system may be configured to adjust the pH if a pH level exceeds a threshold.

In another aspect of the present disclosure, a wastewater treatment system is disclosed. The wastewater treatment system may control the pH level of an anerobic bioreactor. The wastewater treatment system may include the bioreactor. The bioreactor may house a pH sensor for monitoring the pH of wastewater flowing through the bioreactor and a plurality of microorganisms. The wastewater may include sludge which may be broken down by the plurality of microorganisms prior to reaching a membrane cell operatively connected to the bioreactor. The wastewater treatment system may also include a pH adjuster operatively connected to the bioreactor and a control system. The pH adjuster may be configured to adjust the pH if the pH exceeds a threshold. The wastewater treatment system may further include a processor. The wastewater treatment system may also analyze the pH of the bioreactor utilizing data sensed by the pH sensor, while the wastewater treatment may be configured to adjust the pH if a pH level exceeds a threshold

In yet another aspect of the present disclosure, a method for controlling the pH of an anaerobic membrane bioreactor with electrolytic regeneration is disclosed. The method may include flowing wastewater through a bioreactor, wherein a plurality of microorganisms may break down the wastewater during acidification to methanogenesis to form an effluent. The method also may include monitoring a pH of the wastewater in the bioreactor by a pH sensor housed within the bioreactor. The method may further include filtering effluent through a membrane to obtain permeate. The method may also include adjusting the pH of wastewater in the bioreactor to enhance methanogenesis step and filtration of the effluent, wherein the adjusting of the pH may consist of electrolysis. Therefore, it is a primary object, feature, or advantage of the present disclosure to improve over the state of the art.

It is a further object, feature, or advantage of the present disclosure to optimize electrolytic regeneration.

It is a still further object, feature, or advantage of the present disclosure to increase membrane filtration efficiency.

Another object, feature, or advantage of the present disclosure is to reduce chemical applications during treatment.

Yet another object, feature, or advantage of the present disclosure is to provide an eco-friendly wastewater treatment.

Yet another object, feature, or advantage of the present disclosure is to provide a feedback loop to control a pH of the reactor.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 is an illustration of one aspect of the AMBER system of the present disclosure;

FIG. 2 is an illustration of the AMBER control system of the present disclosure;

FIG. 3 is an illustration of one aspect of the bioreactor of the present disclosure;

FIG. 4 is an illustration of one aspect of the EABR system of the present disclosure;

FIG. 5 is an illustration of another aspect of the bioreactor of the present disclosure;

FIG. 6 is a chart illustration chemical oxygen demand (COD) removal efficiency of the AMBER system of the present disclosure;

FIG. 7 is a chart illustrating the total suspended solids (TSS) removal efficiency of the AMBER system of the present disclosure in accordance with one aspect of the present disclosure;

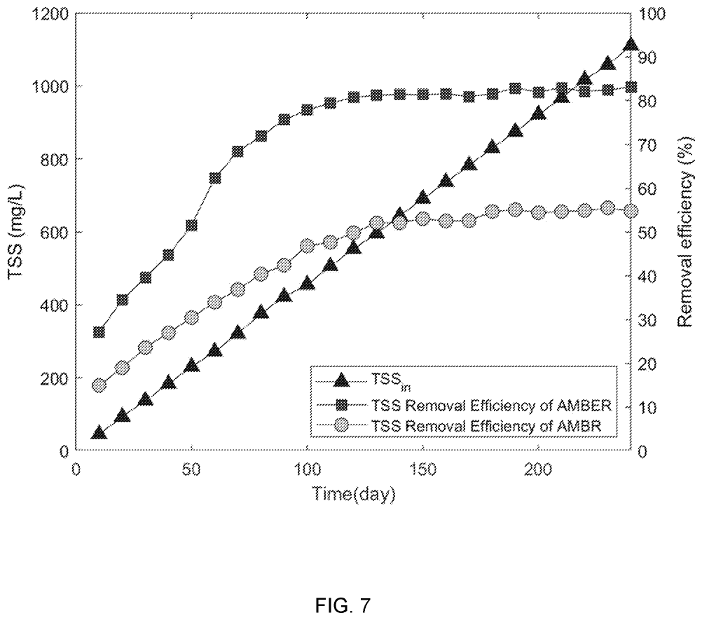

FIG. 8 is a chart illustrating the pH profile in an EABR and an anaerobic baffled reactor (ABR) in accordance with one aspect of the present disclosure;

FIG. 9 is a chart illustrating compartment wise pH profiles for an EABR system in accordance with one aspect of the present disclosure;

FIG. 10 is a chart illustrating the increase COD steps in an EABR and an anaerobic baffled reactor (ABR) in accordance with one aspect of the present disclosure;

FIG. 11 is a chart illustrating the compartment wise profiles of an EABR in accordance with one aspect of the present disclosure;

FIG. 12 is a flowchart illustrating a method of enhancing electrolytic regeneration and membrane filtration of the present disclosure;

FIG. 13 is another flowchart illustration a method of enhancing electrolytic regeneration and membrane filtration of the present disclosure;

FIG. 14 is a flowchart illustrating a method of adjusting the pH profile of the wastewater treatment system with electrolysis; and

FIG. 15 is a flowchart illustrating a method of determining the corrosion on an electrode.

### DETAILED DESCRIPTION

Global reuse of treated wastewater is 5.55 billions of gallons per day (BGD). The reclaimed water is 3% of the total water supply in the United States, which is low in comparison with other countries like Singapore or Israel which is equal to 30% and 20%, respectively. One reason can be the fact that 20% of the US households are not connected to municipal sewage systems and are typically using septic tanks. This means more than 4 billion gallons of wastewater flow through septic systems each day and leach into the ground instead of being recovered. Anaerobic digestion (AD) is widely used on waste treatment for its great capability of organic degradation and energy recovery. However, accumulation of volatile fatty acids (VFAs) caused by impact loadings often leads to the acidification and failure of AD systems. The ABR can be considered as a series of up flow anaerobic sludge bed (UASB) reactors that still play significant role within the field of wastewater treatment plants.

The anaerobic phases of AD consisting of hydrolysis, acidogenesis, acetogenesis, and methanogenesis occur sequentially throughout different compartments in ABR. The design of ABR can not only satisfy the requirements of various microorganisms in terms of habitat but can also reduce the shocks from feed wastewater to the later methanogenesis. In addition, the long solid retention time (SRT) is helpful for the formation of granules Acetogens, and methanogens grow under critical environmental conditions, including low oxidation-reduction potential (ORP) and neutral pH which may range from 6.8 to 7.2, or have a larger or smaller range. Maintaining neutral pH is quite difficult since hydrolysis and fermentation steps produce large amount of VFAs.

Many factors influence the start-up of AD, including their feed composition, strength of influent, volume of inoculum, and reactor configuration. Based on some studies of ABR start-up strategies, a longer hydraulic retention time, a lower COD concentration, and more inoculum should be selected. When acetogens and methanogens were not effective enough to consume VFAs in time, such as during the start-up stage of anaerobic digestion, accumulation of VFAs would become inevitable. Then, pH could drop dramatically and further inhibit the growth of acetogens and methanogens, causing a vicious circle. Therefore, maintaining high alkalinity using chemicals such as NaOH to avoid sudden acidification becomes crucial for running AD reactors. This method provides a stable environment for the growth of acetogens and methanogens, which allows the establishment of a mature microbial community with balanced metabolic capabilities.

However, the maturation of microbial community takes time and the start-up stage of anaerobic digestion is usually long (several weeks). Moreover, high concentration of cations, such as sodium and calcium, might inhibit microbial under some unflavored conditions. The improvement of the metabolic capacity of acetogens and methanogens is the ultimate strategy for eliminating VFA accumulation. Integrating electrochemical (EC) processes into AD process is one of the most effective ways to recover the deficient AD processes. The integration of EC processes into AD may increase the removal of the pollutants, accelerate the conversion of VFAs, upgrade the methane content, increase methane production, and finally maintain an optimal pH level for methanogens growth.

The objectives of the AMBER and EABR development are to upgrade cost and performance of the existing technologies and to meet the requirements of the standards in reusing and recycling water. The wastewater treatment system is a system with numerous advantages over other anaerobic reactors, including longer biomass retention time, high resilience to organic and hydraulic shocks, ability to separate the phases of anaerobic digestion, and lower construction and operation costs. The wastewater treatment system may include an AMBER system or an EABR system. The gradient of pH is maintained to be minimum along the wastewater treatment system which has a significant contribution to the process efficiency. Moreover, the efficiency of these reactors, unlike other anaerobic systems for treating the municipal wastewater, is enough to meet the effluent standards of contaminants. The slow growth rates of anaerobic microorganisms make the establishment of the most suitable microbial population critical to the prompt start-up of the wastewater treatment system. Prompt start-up is one of the advantages of wastewater treatment system which is essential for highly efficient operation of the anaerobic process.

To identify the wastewater treatment performance and to appraise the filtration behavior of a membrane bioreactor, a combination of an upgraded anaerobic baffled reactor with an electrolysis process and a membrane filtration process was designed, constructed, and brought online. The wastewater treatment system is a bio-electrochemical process that is expected to be simultaneously efficient in biogas augmentation and in fouling mitigation. In the wastewater treatment system, electrolysis was applied to create an integrated system that is capable of reviving pH while improving biogas quality and quantity in both EABR and AMBER systems and membrane efficiency in an AMBER system. The electrodes can revive a pH unit in a shorter period of time compared to the chemicals used to adjust pH. Furthermore, the application of the electrolysis process can affect the start-up time of anaerobic. The use of electrolysis in the wastewater treatment system improves different aspects significantly such as fouling occurrence, flux recovery, and the formation of the extracellular polymeric substances (EPS) on the membrane surface.

Wastewater is used water that has been affected by domestic, industrial, and commercial use. The constant release of wastewater into the environment has significantly impacted the freshwater resources worldwide. Wastewater effluents are released to a variety of environments and freshwater resources including lakes, ponds, streams, rivers, estuaries, and oceans. Adequate wastewater treatment prior to its discharge into the environment is essential to reduce health issues and environmental effects of microorganisms and organic content in the wastewater.

The AMBER is simultaneously efficient in both anaerobic digestion and an optimized filtration process. A higher hydrogen concentration in the anaerobic process leads to excessive accumulation of higher molecular weight volatile fatty acids, and the pH consequently drops further, resulting in more flux reaching the membrane. The anaerobic process ultimately fails if the situation is left uncorrected. To maintain the pH stability and the efficiency of the membrane, an electrolysis process is integrated into the anaerobic membrane bioreactor (AMBR). The electrolysis process sustains the pH in the optimized range for anaerobic process while enhancing the removal of contaminants in the anaerobic bioreactor (ABR), augmented biogas production and fouling mitigation.

The AMBER has the ability to biologically treat wastewater and produce biogas, produce completely hygienic effluents, and eliminate the problem of membrane clogging. In addition, the wastewater treatment system does not require pre-treatment or post-treatment and can also be used as a proposed package to produce effluent in accordance with national and international standards. The reactors in the wastewater treatment system may capably remove more than 80% of the wastewater organic matter and convert it into biogas. The produced biogas is then used to wash the nanocomposite membrane (silver-modified polymer) and finally leads to a self-washable membrane. The AMBER combines three different technologies: biodegradation, electrochemistry, and membrane separation. The EABR combines two different technologies, biodegradation and electrochemistry. To improve the performance of an AMBER and an EABR the electrolysis process has been integrated into the system to optimize the electrolytic regeneration. Membranes can be used in aerobic bioreactors and anerobic bioreactors, such as the EABR. Anerobic bioreactors are more efficient in removing organic matter, recovering energy, and reducing the sludge produced due to the anerobic bacterial community. Less material accumulates on the surface of anaerobic membranes. However, clogging and flux reductions can reduce the efficiency of the membrane bioreactor. By controlling the pH of the AMBER system, clogging of the membrane and flux reaching the membrane are reduced, increasing the efficiency of the membrane to filter the effluent.

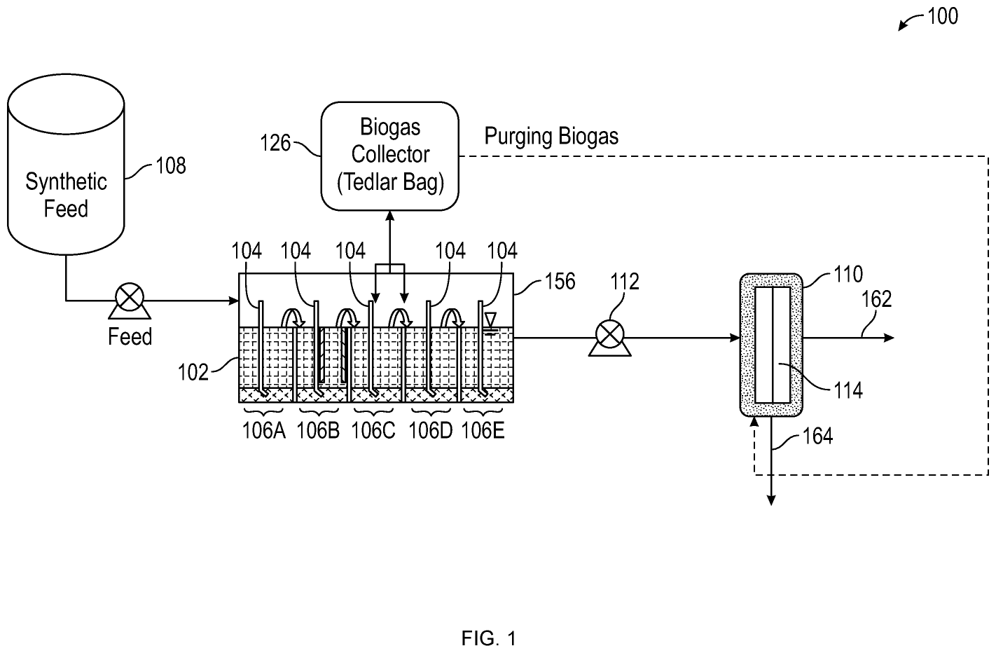

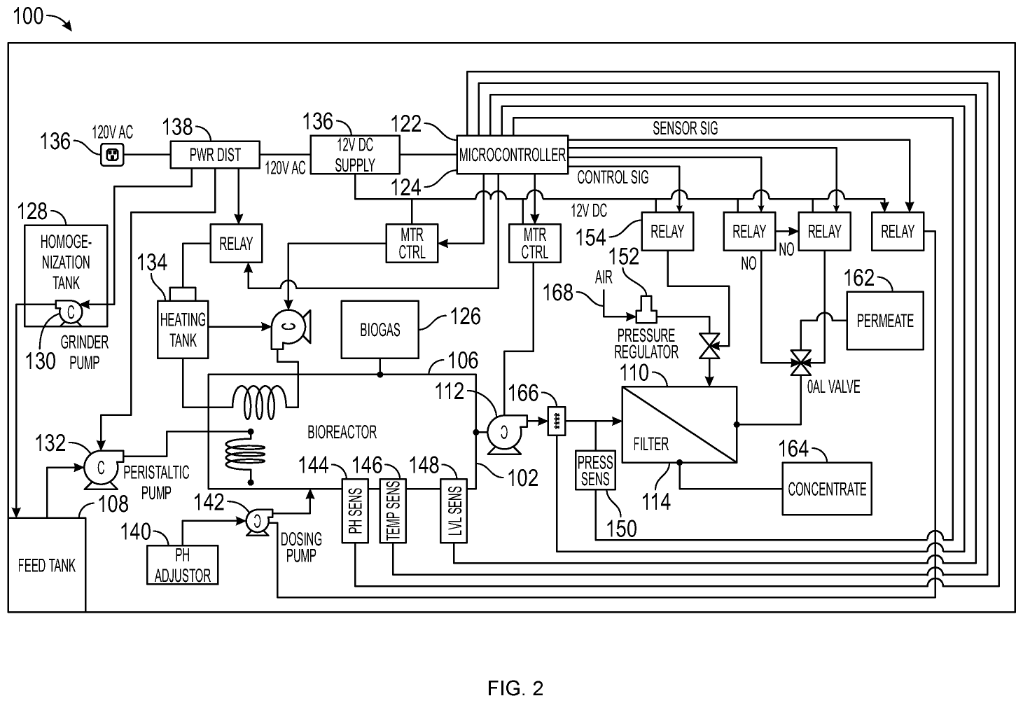

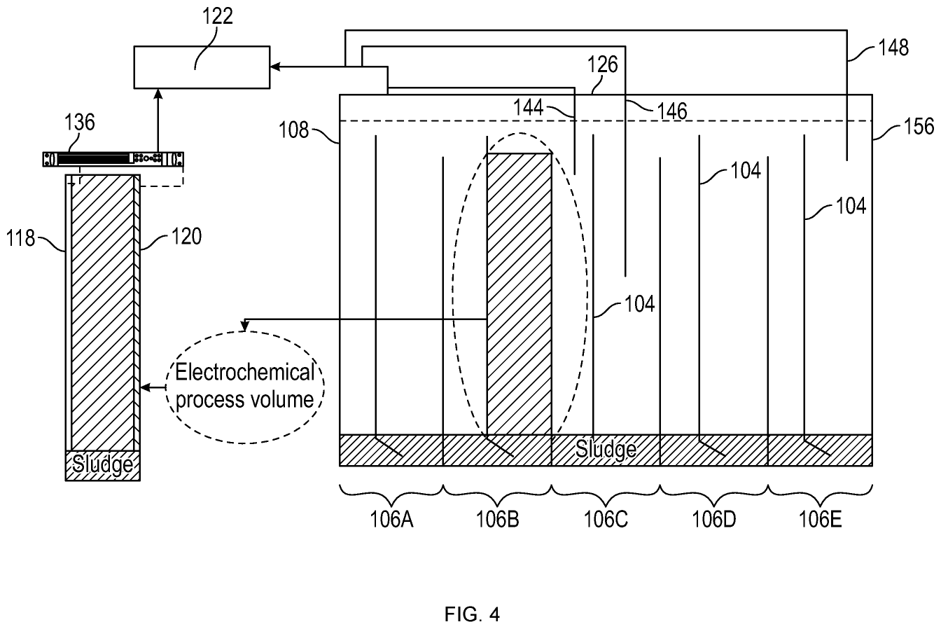

The wastewater treatment system 100 may include a multi-stage bioreactor 102 with a membrane cell 110, as shown in FIGS. 1-5, where biomass retention may be increased by passing a current through several baffles 104 separating the reactor into chambers 106, 106A, 106B, 106C, 106D, 106E. Each chamber 106 performs different parts of the wastewater treatment. In other aspects one or more of the chambers may perform the same part of the wastewater treatment. The bioreactor 102, may be an anerobic bioreactor with electrolytic regeneration (EABR) if a membrane cell is present than the reactor becomes an AMBER. The baffles 104, such as vertical baffles 104, may direct the flow from the inlet 108 or feed tank 108 of the reactor to the membrane outlet 112. The sludge and effluent may be separated prior to the effluent reaching the membrane 114 or filter 114. The chambers 106 may be used to regulate the upstream flow of wastewater through a series of baffles. The wastewater may be treated using anaerobic microorganisms such as mesophile bacteria, releasing methane as a byproduct.

An AMBER can have two configurations. In the first configuration, the membrane 114 can be placed directly inside the bioreactor 102. When the membrane 114 is embedded directly in the bioreactor 102, it may come into contact with sewage as well as sludge. This type of membrane 114 may submerged and the system is called submerged membrane bioreactor (SMBR). In the second configuration, the membrane 114 may be placed in a tank or membrane cell 110 separate from the reactor, which has advantages such as higher flow rate, lower membrane surface, higher system density, ability to remove nutrients, less sensitivity to input changes, less leaching due to greater recovery, and longer lifetime of the membrane.

However, the AMBER is still limited by fouling problems, cessation of the process to clean the membrane, and the use of chemicals within the reactor. Fouling is the accumulation of substances on the membrane surface or within the membrane pores, resulting in a deterioration of the membrane performance. The substances reduce the flux, or the daily or hourly water flow through the membranes surface area, and increase the working pressure of the membrane, thus increasing the cost and the need to replace the membrane.

Factors that may influence the filtration of the effluent through the membrane 114 include the membrane characteristics, wastewater characteristics, and the operating characteristics of the reactor. The membrane characteristics can include the pore size, hydrophilicity of the membrane 114, surface roughness, and surface charge. The wastewater or bioreactor effluent characteristics can include biomass concentration, rheology, consistency, particle size and structures, and colloid/SMP concentration. The operating conditions can include the pH level, parameters of the electrolytic process, and temperature. By maintaining the pH at an optimum level, the bioreactor can increase the working pressure of the membrane 114 and reduce flux reduction reaching the membrane 114, thereby increasing the overall efficiency of the AMBER. The disclosed system using electrolysis increases the efficiency of controlling the pH in the bioreactor and increasing the efficiency of a membrane if a membrane is present.

The special hydraulic feature of the wastewater treatment system separates the hydraulic retention time and the retention time of solids, and in this way, proper wastewater treatment is achieved at low retention times. Due to the fact that this reactor is divided into separate chambers, the system can withstand organic and hydraulic shocks, At the same time, the output of this reactor has a high microbial load, which may make the use of disinfection methods or membrane filtration after it inevitable.

The bioreactor 102 may be used as pre-treatment before the filtration by the membrane 114. The bioreactor 102 with biological digestion of organic matter, wastewater solids and biogas production may be used as pre-treatment of the wastewater or bioreactor effluent prior to the effluent reaching the membrane 114 and reducing the microbial load of its output may be the responsibility of the nanocomposite membrane 114 (antibacterial). The membrane 114 may reduce the microbial load of the bioreactor 102. In other aspects of the present disclosure, other methods may be used to reduce the microbial load of the output from the reactor, such as UV or carbon filters. In some aspects of the present disclosure, in order for the bioreactor 102 to complete the production of biogas antibacterial property of the membrane 114, biogas must be used as a backwash of the membrane 114. The backwash may be the permeate from the membrane 114. The use of the membrane's backwash has two advantages: reducing clogging and eliminating the need for chemicals (which leads to the production of by-products or increased TSS). Backwashing the membrane 114 reduces fouling of the surface membrane by pumping permeate through the membrane 114. while the concentrate is fully opened. In addition, air scouring may be used to reduce fouling.

The produced permeate may be circulated in the membrane cell 110 to clean the open membrane 114. In this way, the 114 surface of the membrane 114 is always clean and maximum flow flux is achieved in them. The membrane cell 110 may be responsible for removing the organic charge of the effluent produced by the bioreactor 102 output. The membrane 114 may be negatively charged. Some cations from mixed liquor suspended solids (MLSS) may react with the negative charge to produce fouling. By controlling the pH of the AMBER system 100, the amount of MLSS reaching the membrane may be reduced.

The wastewater engrossing MLSS and TSS may be treated using anaerobic microorganisms such as mesophile bacteria, releasing methane or biogas as a byproduct. Solid and liquid products produced by the breakdown can be discharged through a digestor. The anaerobes may break down complex organic compounds in the wastewater into simpler, short-chain volatile organic acids during the acid-forming phase. The second phase, known as the methane-production phase, may consist of two steps: acetogenesis, where anaerobes synthesize organic acids to form acetate, hydrogen gas, and carbon dioxide; and methanogenesis, where the anaerobic microorganisms then act upon these newly formed molecules to form methane gas and carbon dioxide. Methane gas and carbon dioxide can be reclaimed for use as fuel, while the wastewater can be routed for further treatment and/or discharge. The methane can later be combusted to generate electricity or heat. In anaerobic process, significant variation of pH value and alkalinity can occur because of substrate influence, and acidic-alkaline compounds may be produced during organic matters decomposition process. In an anerobic bioreactor, methanogenesis bacteria is very sensitive to changes in the pH value and alkalinity. Therefore, maintenance of optimum operation conditions is mandatory. The suitable pH value for the optimized performance of anaerobic processes is in the range of 6.8-7.2, in other aspects of the present disclosure, the pH range may be larger or smaller. The pH range may also be higher or lower. Sudden variations in pH values can affect the anaerobic bacteria ability to break down the organic matter in the wastewater, thereby increasing the TSS flowing to the membrane reducing the membrane's ability to filter.

Electrolysis can be used to control the variation in pH value, reducing or eliminating the need for chemicals to be used inside the reactor. Using electrolysis, an electrical field may be applied to electrodes 116 in an aqueous solution. The electrolysis system may have at least one or two pairs of electrodes 116, and each pair may include an anode 118 and a cathode 120. The electrodes may be placed in at least one of the reactor's chambers 106. To maintain the optimal pH value using electrolysis, sufficient alkalinity in the wastewater is required. The alkalinity is initially in the form of bicarbonate. According to the reaction (1), it is in equilibrium with existing carbon dioxide in biogas, at a certain pH value.

OH⁻+CO₂↔HCO₃⁻ (1)

An electrical field may be applied to the electrodes 116 causing electrolysis of the water. The electrolysis may maintain a load balance producing oxygen gas and proton formation at the anode 118. The proton may be (H⁺). Hydrogen gas and hydroxide may be produced at the cathode 120. Consequently, the pH value may increase close to the cathode 120, while a reduction in pH value may be observable in the anode 118 sector. By the reducing pH value around the anode 118, reaction 1 proceeds towards the production of carbon dioxide and hydroxide. Reactions 2-6 occur at the anode 118 and the cathode 120.
At the anode 118:

M→Mⁿ⁺+ne⁻ (2)

2H2O→O_{2(g)}+4H⁺+4e⁻ (3)
At the cathode 120:

2H₂O+2e⁻→H_{2(g)}+2OH⁻ (4)

2H₃O++2e⁻→2H₂O+H_{2(g)} (5)

Mn⁺+ne⁺→M (6)

Reactions 3 and 4 produce proton and hydroxide anions resulting in a pH gradient between the electrodes 116 or the anode 118 and the cathode 120. Reaction 3 reduces the pH around the anode 118, allowing reaction 1 to proceed towards the production of carbon dioxide and the hydroxide anion. Foam forms around the anode from the production of carbon dioxide gas as a result of the displacement of the balance of the system. After the power outage due to the low carbon dioxide solubility in accordance with Henry's law, reaction 1 becomes irreversible. As a result, the pH increases due to the displacement of the bicarbonate balance and the release of carbon dioxide gas around the anode 118. The increase in pH affects the entire reactor and raises the pH to the optimal range for methanogenesis to start or continue.

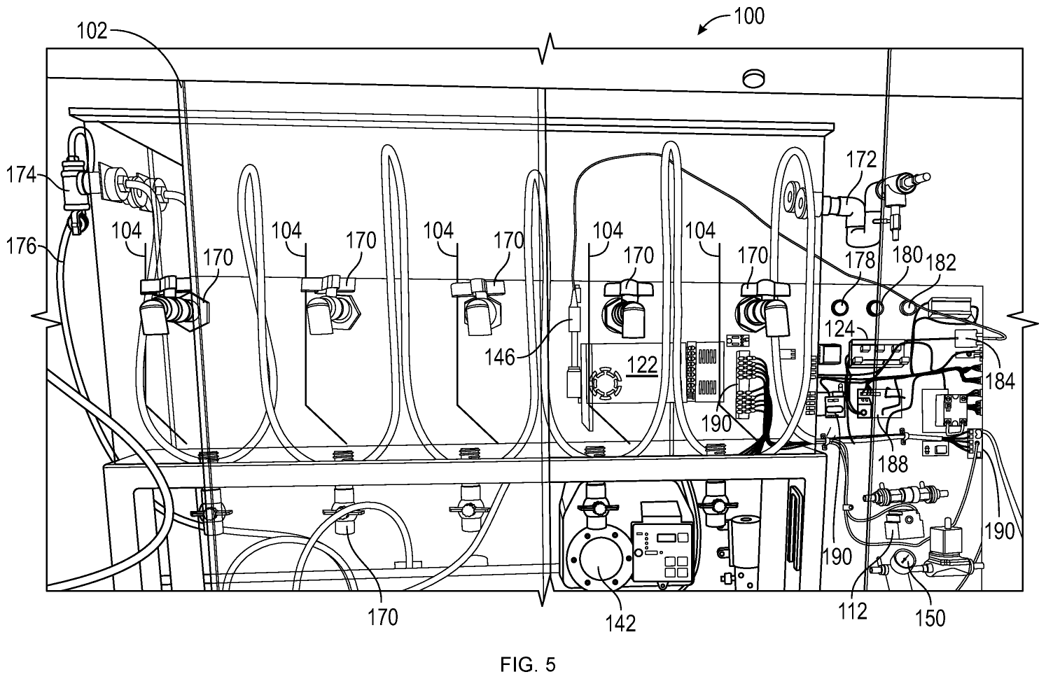

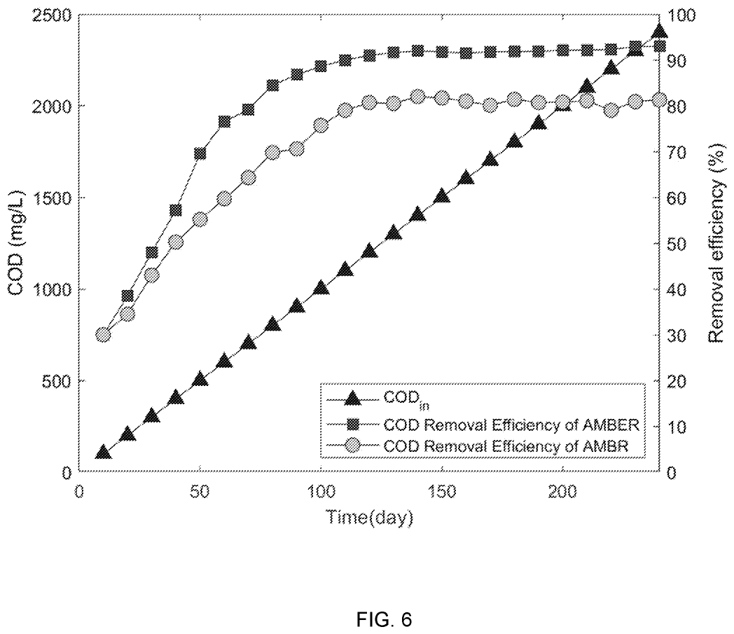

The anode 118 ingredients or chemical elements may be oxidized to form the metal cations in the wastewater when the electrical field is applied to the electrodes 116. These metal cations act as coagulants. By decreasing the zeta potential of colloidal and suspended materials in the wastewater, forming clots, and trapping contaminants, degradation occurs while the oxygen and hydrogen gas bubbles formed cause the organic matter to float, thereby decreasing the amount of flux that reaches the membrane. FIG. 5 illustrates the chemical oxygen demand (COD) removal efficiency of the AMBER system. Using electrolysis to control the pH can increase the COD removal efficiency by over 10%. Furthermore, the use of electrolysis can increase the TSS removal efficiency by over 20%, as illustrated in FIG. 6.

Although the VFA products are the highest in the first compartment and these could be substrates to the following compartments, all of the VFAs could not be further converted into biogas under the limitation of thermodynamics. As a result, an extra energy input may be applied in order to convert VFAs to biogas. This extra source can be applied through the EC process. EC process can involve many steps and the main steps is summarized in the following three steps as described by:
1. Formation of coagulants by electrolytic oxidation of the electrode,
2. Destabilization of the contaminants,
3. Breaking of emulsions.
   The dominant mechanism may vary throughout the dynamic process as the reaction progresses. The dominant mechanism will almost certainly shift with changes in operating parameters and pollution types. In conclusion, many factors including electrodes material associated with EC process may affect the final efficiency. The electrochemistry reaction associated with electrolytic regeneration processes by iron (Fe) as following, starting with reaction 7:

Fe→Fe²⁺+2e⁻ (7)

The following main reactions occur in the EC cell when iron is used as electrode material:

### Reactions in a Cathode 120

2H₂O+2e⁻→H_{2(g)}+2OH⁻ (8)

8H⁺(aq)+8e⁻→4H_{2(g)} (9)

As electrochemistry depends on thermodynamic and kinetic parameters, it can be considered as an accelerated corrosion process. The rate of reaction in Equation (9) will depend on the removal of H⁺ via H₂ evolution.

### Reactions in an Anode 118

2H₂O(1)→O₂(g)+4H⁺+4e⁻ (10)

Fe²⁺(aq)+2OH⁻(aq)→Fe(OH)₂(s) (11)

2Fe²⁺(aq)+½O2(g)+5H2O(1)→2Fe(OH)₂(s)+4H⁺(aq) (12)

The production of OH⁻ ion near the cathode as in shown in Equation (8) expects to cause an increase in the pH of the medium. Meanwhile, the anode electrolysis and dissolves ferrous ions into solution as shown in equations 10-12.

The reactions occurring at the anode 118 and the cathode 120 can be affected by the electrode 116 material and ions in the electrolyte environment. The electrode 116 material may be iron, aluminum, titanium, titanium coated with metal oxides, stainless steel, lead dioxide, gold, platinum, carbonate, copper, brass, or nickel. The electrode 116 material can increase or decrease the COD removal and turbidity, or generate larger amounts of foam, floating more pollutants. Corrosion of the electrode 116 material can decrease the effectiveness of the electrodes. The material of the electrodes 116 may be chosen based off the conductivity of the material, the effect on coagulation and flocculation, volumetric mass, oxidation resistance, the generated electrical current intensity, the effect of the material on the growth of the anaerobic microorganisms, and effect on the membrane.

The electrode 116 materials can generate different electrical current intensities and can affect the metal separation from the electrodes surface, the rate of metal dissolution in the wastewater, the amount of electron transfer, and the required time for reviving a pH unit. The current density may be calculated from the amount of applied current over the surface area of the electrodes. The pH voltage may be 5 volts, the voltage may also be higher or lower. The voltage may be applied through the control system. The voltage may depend on the pH. Changes to the electrical current density can increase or decrease the required time to revive the pH value. When the current density increases, the revival time for the pH unit decreases. The revival time may be a set time or may vary. The length of the revival time may be increased or reduced if the current is adjusted. For exemplary purposes only, if the current is increased the revival time may decrease or in other aspects increasing the current may increase revival time. The feedback loop 122 may adjust the revival time by increasing or decreasing the current. Recovery of the pH value occurs due to the electrolysis which accelerates due to the current density. Electrolysis time needed to recover the pH value has an inverse relationship with current density.

Increasing the distance between the electrodes 116 decreases current density, while increasing the contact surface of the electrode 116 with the wastewater increases current density. When the distance between the electrodes 116 decreases and the contact surface of the electrodes 116 is increased, more wastewater is exposed to the electrolysis and efficiency is improved. Electrolysis time can be shortened by increasing the distance between the cathode 120 and the anode 118, making the pH unit revival time longer while reducing energy consumption. The electrolysis may create an integrated system that is capable of reviving pH while improving biogas quality and quantity as well as reducing the TSS that reaches the membrane 114. The electrodes 116 can revive a pH unit in a shorter period of time compared to the chemicals used to adjust pH, such as NaOH.

Due to the sensitivity of anaerobic systems in the process of digestion, temperature and pH control is necessary, for which purpose, by installing a control system 122 or feedback loop 122, the wastewater treatment systems may be controlled online, remotely, or at a sewage plant. Due to a control system, the wastewater treatment systems may require minimal human involvement or may be completely autonomous. The control system 122 may include a data logging system for controlling the operation and environmental parameters in both the bioreactor 102 and membrane cell 110. The control system 122 may allow the technology to be well-adopted for the decentralized treatment of rural and urban sewage, and it may also reduce the need for complex maintenance and control as well as skilled manufacturers and operators. It may further enable 24/7 monitoring of the system's operation parameters including pH, temperature, fluid level, the backwash of the membrane, pressure drop, etc., for both the bioreactor and the filtration processes. The control system 122 or feedback loop may contain a calibration curve to determine what voltage, how long to apply the voltage, or other factors to adjust the pH. Calibration factors that may be included in the pH calibration are the temperature of the bioreactor 102, whether sensed from a temperature sensor or a set value, the electrode material, the current applied, whether the current can be adjusted or is a set amount, how far apart the electrodes are, the size of the bioreactor, the size of the compartments, the type of wastewater, the level of the wastewater, effluent level, influent level, rate the influent is entering the reactor, the types of microbes, the amount of microbial activity and/or any other factors. The calibration factors may be sensed by one or more sensors, input into the control system or set at a set value.

For example, if the pH sensor measures a high pH, the feedback loop stops a current to lower pH or shuts the feedback loop off, allowing alkalinity to be consumed by the bioreactor 102, lowering the pH. If the pH sensor measures a low pH, the feedback loop may start or increase a current to raise the pH, increasing the alkalinity in the bioreactor 102. Temperature may be used as an input into the control system or feedback loop. The feedback loop 122 may use temperature as an input and if the temperature changes the feedback loop may adjust the current or revival time. For example, if the temperature probe reads a high temperature or low temperature that may lower the pH, the feedback loop may adjust the temperature of the bioreactor 102, increase the current, start a current or increase or decrease the revival time to maintain the pH level or increase the pH. If the temperature probe measures a high temperature or low temperature that may increase the pH then the feedback loop may adjust the temperature of the bioreactor, decease the current, stop the current, or increase or decrease the revival time to maintain the pH or lower the pH.

The wastewater treatment system 100 may have at least one microcontroller 124 or processor 124 for analyzing the data and determining what operation parameters need to be adjusted or maintained, such as voltage applied to the electrodes 116, or the temperature. The microcontroller 124 may control the operation and functionality of the wastewater treatment system 100. The microcontroller 124 may consist of a circuitry, such as a printed circuit board, chips, one or more microprocessors, digital signal processors, application-specific integrated circuits (ASIC), central processing units, or other devices suitable for controlling the bioreactor 102. The microcontroller 124 may also process user input to determine commands implemented by bioreactor 102 in response to sensor readings or sent to the bioreactor 102 or wastewater treatment system 100 from a remote device through a transceiver. The microcontroller 124 may also include programs, scripts, and instructions that may be implemented to operate the wastewater treatment system 100. The components of the wastewater treatment system 100 may be electrically connected utilizing any number of wires, contact points, leads, busses, wireless interfaces, or so forth. The microcontroller 124 may be operably connected to the bioreactor 102, biogas collector 126, homogenization tank 128, grinder pump 130, feed tank 108, peristaltic pump 132, heating tank 134, power supply 136, power adjuster 138, relay 154, the relay may be a command relay channel or an incoming relay channel, pH adjuster 140, dosing pump 142, pH sensors 144, temperature sensors 146, level sensors 148, pressure sensors 150, the membrane cell 110, EABR effluent, membrane outlet 112, pressure regulators 152 and other components of the wastewater treatment system 100.

Inlet wastewater may enter the homogenization tank 128 with a grinder pump 130 to reduce the size of the solids in the wastewater, grinding the solids into a sludge or slurry. Then the sludge may move to a feed tank 108. The feed tank 108 may be combined with the homogenization tank 128. The feed tank 108 may feed the inlet wastewater into the bioreactor 102. The feed tank 108 may utilize a pump 132, such as a peristaltic pump to feed the inlet wastewater into the bioreactor 102. A reactor may have an anaerobic baffle reactor with the ability to remove organic matter and produce biogas and may be controlled by control system 122.

The bioreactor 102 may have a housing 156 having a lateral wall 158 opposing a longitudinal wall 160. The longitudinal wall 160 may be divided into a plurality of chambers 106. The last chamber 106 may have an outlet leading to the membrane outlet 112. The plurality of chambers may be separated by one or more baffles 104 to direct the flow of the wastewater and effluent through the bioreactor 102. The bioreactor may contain a pH sensor 144 for monitoring the pH levels and a temperature sensor 146 for monitoring the temperature of the bioreactor 102. The bioreactor 102 may also contain at least one pair of electrodes 116. The electrodes 116 may be placed in one or more chambers 106 or in all the reactor chambers 106. The electrodes 116 may be installed in the up flow section of the section chamber and adhered to the walls of the baffles 104. By monitoring the pH in the second chamber 106B, the pH of all chambers 106A, 106B, 106C, 106D and 106E can be adjusted allowing optimal pH for methanogenesis to occur. Biogas may be collected from the bioreactor by the biogas collector 126 operatively connected to the bioreactor 102. The collector may be a tedlar bag. Microorganisms may be submerged in a liquid growth medium in the bioreactor or attached to a surface of a solid growth medium (not shown).

The wastewater treatment system 100 may include a multistage bioreactor 102. The inlet wastewater may enter chamber one 106A which may be separated from chamber two 106B with a baffle 104. The baffle 104 may consist of plexiglass. Hydrolysis may occur in chamber one 106A, where the complex organic molecules may be broken down into simple sugars. The inlet wastewater may then flow into chamber two 106B. Acidogenesis may take place in chamber two 106B, where the remaining components may be broken down by acidogenic bacteria. Acidogenesis, reduces the pH of the reactor through the production of acids. The pH sensor 144 and electrodes 116 may be located in chamber two 106B. The wastewater may then move to chamber three 106C. Acetogenesis may take place in chamber three 106C where the simple molecules created by the acidogenesis phase may be further digested by acetogens. The wastewater may then move to chamber four 106D and then to chamber five 106E. The last stage, methanogenesis, may occur in chamber four 106D or 106E. The EC process may occur before methanogenesis. Methanogenesis is where methanogens use the intermediate products of the preceding stages to convert the products into methane, carbon dioxide and water. Methanogenesis is sensitive to both high and low pHs and occurs between pH 6.5 and pH 8. The last chamber 106E may have a level sensor 148 to maintain safe levels of wastewater in the bioreactor 102.

The wastewater enters the chambers at the bottom and needs to pass through the sludge to move up and to the next compartment. To retain any possible scum formed in the up-flow chamber, each chamber may have an outlet 170 slightly below the liquid surface

In one aspect of the wastewater treatment system 100, two pairs of electrodes 116 may be made of iron with dimensions of 37×7.5×0.2 cm (length×width×thickness) that may be halved and placed symmetrically in the bioreactor 102 to allow the use of a power supply under critical conditions. A pH adjuster 140 may be operatively connected to the bioreactor. The pH adjustor 140 may adjust the pH using a dosing pump 142 or through applying a voltage. Adjustment of pH values may be achieved through the use of a measurement probe, a signal boosting pre-amplifier, and the microcontroller 124. The microcontroller 124 may be programmed to signal a chemical dosing pump to add chemicals to the process fluid in order to move the pH value toward a desired setpoint.

In some aspects of the present disclosure, an EABR reactor is used. The EABR reactor may have one or more chambers 106. For example purposes only, the EABR was 100 cm in length, 20 cm in width and 45 cm in height, with 5 compartments that are sequentially named 106A through 106E with an effective volume of 80 L. The EC process may occur in the upward part of the second compartment 106B. The electrolysis system may be comprised of a pair of identical iron-plate electrodes 116 cut into equal pieces of a total surface area of 277.5 cm² and then placed inside the reactor symmetrically and submerged in the wastewater above the sludge. In some aspects of the present disclosure, the surface area of the electrodes may be larger or smaller. The electrical current densities may be 3 mA/cm², or the current density may be larger or smaller. Synthetic wastewater was prepared in a 120 L polyethylene open head drum (Grainger, USA) using molasses (1.487 g molasses ≃1 g COD) and then fed into the reactor by a dosing pump with a capacity of 50 L/h and a pressure of 3 bar. This is the second iteration of the bioreactor that we manufactured and ran. In addition, the substrate contained 6×10⁻⁴ g_{K HPO}/g_{COD} as the phosphate source and 7×10⁻³ g_{NH Cl}/g_{COD} as the nitrogen source. All chemicals used for sample preparation, chemical extraction and gas chromatography (GC) detection method were of GC-MS grade, from Sigma-Aldrich. During all the phases of AD (hydrolysis, acidogenesis, acetogenesis, and methanogenesis), the reactor temperature was controlled and maintained at (37±2) ° C. To maintain a pH of 6.8 to 7.2, the pH of the upward part of the third compartment, 106C, was recorded using a feedback control system and then the pH of the second compartment, 106B adjusted automatically by applying electrolysis process through the programmed control system 122 or feedback loop 122.

Volatile fatty acids are important intermediate products in the generation of methane, and their concentrations affect the performance of reactors. The VFAs are produced during the acidification process in the at least one or more of the first compartments, such as 106A and 106B. Then, this intermediate product consumes in the last compartments, such as 106C through 106E. However, the VFAs level in the reactor should be less because of the aggregation of VFAs in the reactor that leads to the inhibition of methanogens.

The two main VFAs observed in the compartments of EABR process were acetic acid and propionic acid. These intermediate products are consumed as a food source for the subsequent microbial communities. Of these VFAs, acetic acid is considered as the key intermediate product for methane production. In the EABR, the concentration of acetic acid was maximum in the first chamber 106A and it decreased along the reactor. Alkalinity should decrease in the former compartments caused by accumulation of VFAs, while it increases in the latter compartments for the production of CO₂⁻ and HCO— by methanogens. Analysis of the EABR with an influent of 600 mg/L indicated that the VFAs were close to zero by the third compartment, 106C, which are in agreement with COD removal results.

A heating tank 134 or cooling jacket may be operatively connected to the bioreactor 102 and the microcontroller 124. The heating tank 134 or cooling jacket maintains the temperature of the bioreactor, such as maintain the temperature at 35-37° C., in other aspects the temperature may be kept at a higher or lower temperature, such as 31° C. If the temperature sensor 146 senses that the temperature is too high and affecting the pH of the system, the heating tank 134 or cooling jacket may reduce the temperature of the bioreactor 102. If the temperature sensor 146 detects that the pH is too low based on a temperature range for maintaining optimal pH, the heating tank 134 can increase the temperature of the bioreactor 102 or the cooling jacket can reduce power or turn off to increase the temperature of the bioreactor 102. In some aspects in the above system, instead of placing the bioreactor 102 in a hot water bath to increase the temperature, an ambient heating system may be used, which may be much more efficient than the conventional system. The AMBER system 100 can protect itself against any shocks.

A level sensor 148 may be operatively connected to the bioreactor 102 and the microcontroller 124 and placed in one of the chambers 106 to sense the effluent level. Level sensors 148 can be supplied in many forms from immersed float sensors to non-contact ultrasonic or radar probes. The level sensors 148 may ensure that the wastewater does not overflow, that pumps do not run dry, and that valves open and close as demanded, ensuring flow is reliably available in the right place at the right time in the right quantity.

The output of the bioreactor 102 enters the nanocomposite membrane module or membrane cell 110 through an effluent outlet or membrane outlet 112 such as a pump and after purification is transferred to the final product tanks for permeate 162 and concentrate 164. Permeate return flow may be used for reverse membrane washing. The effluent outlet may be operatively connected to the microcontroller 124 to control flow into the membrane cell 110. The effluent outlet may contain a pressure sensor 150 to monitor the pressure of the wastewater reaching the membrane. The outlet may also contain a flux sensor 166 to determine if the flux levels are in appropriate operation flux rate Water that passes through the membrane may be directed towards a permeate channel. The permeate may have low levels of suspended solids. Disinfectant may not be required. More concentrated materials may be directed towards a concentrate channel. The concentrate containing solids can be recycled back to the reactor. A pump, vacuum, or pressurized system may move the wastewater through the membrane. An air scour system 168 may use to reduce the material build up on the membrane.

By controlling the pH of the system, the quality of the effluent in terms of organic and microbial load prior to reaching the membrane may increase, reducing the stress on the membrane. Maintaining an optimal pH reduces the growth and adhesion of bacteria to the membrane surface, thereby reducing biological clogging and consequently reducing the need for backwashing.

As waste water enters in through an influent inlet 174 through piping 176 the waste water travels through the bioreactor 102 under the baffles 104 and exits through an effluent outlet 172. A motor control 188 controls the rate that the waste water enters the inlet so the water stays below a certain level, as measured by the level sensor 148. Each chamber contains an outlet 170 allowing the wastewater to exit the chamber for testing or if the levels become too high. The control system 122 receives inputs from the one or more sensors, including the pH sensor 144, the temperature sensor 146, a level sensor 148 or a pressure sensor 150. The sensor data is communicated either directly to the control system 122 such as through various cords or indirectly such as through wireless communication. The control system monitors the data received from the inputs. The data may be communicated from one or more sensors to an incoming relay channel 184 before reaching the microprocessor 124. If an adjust in the wastewater treatment system 100 needs to be made the control system determines what adjustment needs to be made. The control system sends the commands through command relay channels 190 as shown in FIG. 5. The command relay channels 190 communicate the command to either a motor control 188 or the power distribution 138. For example, if the control system receives a low pH reading from the pH sensor, the control system determines that a voltage should be applied to the electrodes, the control system 122 sends the command through a command relay 190 to the power distribution 138, which then sends a voltage to the electrodes and provides a current density, increasing the pH. In another example, the temperature probe 148 communicates the reading to the control system 122, the control system determines the temperature is low and determines that the heating tank needs to run. The control system 122 sends a command to a motor control 188 for the heating pump to start running, thereby increasing the temperature of the reactor. The control system may analysis the inputs it receives against a calibration curve to determine what actions needs to be taken. The control system 122 may have alerts or threshold indicators to determine if the inputs are within a threshold, whether certain motors are running, or whether the EC process is ongoing. A pH alert 178 may indicate whether the pH is within a certain threshold or whether the EC process is currently running to adjust the pH. A temperature alert 180 may signal that the temperature has exceeded a certain threshold. A pressure alert 182 may signal if the pressure is within a certain threshold. For example purposes only, the alerts may be a certain color, or be lit when the inputs are within a threshold or outside a threshold.

In one example, during the startup phase, the bioreactor was fed with 70% sludge and 30% synthetic feed with 50 mg/L as COD. The bioreactor was inoculated with the sludge, having 64% volatile solids (VTS) and pH of 7.5, taken from the anaerobic digester of the Rapid City Water Reclamation plant as the initial seed. The bioreactor then remained untouched for 7 days before being fed with COD of 50 mg/L for two weeks. A dosing pump was used to feed the bioreactor with synthetic wastewater while the COD was gradually doubled to eventually reach 600 mg/L. The efficiency of COD removal of the bioreactor without any modifications is determined to be 72%. The pH of the bioreactor had been controlled by adding alkalinity (Na₂CO₃) to the feed tank. The bioreactor's temperature was maintained between 35-37° C. for the best performance. The composition of the influent containing molasses and Na₂CO₃ alkalinity (as CaCO₃), NH₄Cl, and K₂HPO₄, were also added to regulate the COD/N/P ratio to 100:5:1. The electrolysis process was in line in the startup phase, and it was capable of pH recovery as expected. The COD, pH, and alkalinity were measured regularly as described in the APHA Standard Methods for the Examination of Water and Wastewater. The VFA composition was measured at all the comportments to investigate the effect of the optimization on the VFA composition.

In another example, during the startup phase the EC process was integrated into the ABR the bioreactor in order to observe the effect of the modification on the startup time while increasing COD from 50 mg/L to 600 mg/L without adding any chemicals (from the first day of inoculation of the sludge into the bioreactor). Anaerobic sludge from the AD system of Rapid City Water Reclamation Division facilities was used as the inoculation sludge. The inoculation sludge may be under mesophilic conditions (37±1° C.). The volatile solid (VS) of the sludge was 63%. The inoculation amount of the sludge was approximately two third of the effective volume of the EABR reactor. The EABR initially was fed with COD of 50 mg/L of the synthetic wastewater feed at 24 hour HRT. The influent concentration was subsequently doubled up after 3 days of stable performance which was evaluated by the pH profile (the steady-state performance was defined when the change in pH profile remained below 3%). The synthetic wastewater with ranged concentration (from 50 mg/L to 600 mg/L) was introduced into the EABR during the start-up stage. And after 12 days, the influent concentration was maintained at 600 mg/L for the rest of the EABR operation. After 36 days, the electrolysis was turned off and the ABR was operated and controlled in the traditional way using chemicals for pH adjustment. In some aspects of the present disclosure, electrolysis may be used longer or shorter than 36 days.

This start-up strategy was examined to ensure growing microorganism were not overloaded and better solids accumulation during the operation was encouraged. The effect of the electrolytic regeneration on the VFA composition, start-up time, and pH profile for a low strength wastewater treatment [COD=600 mg/L] was analyzed. The low strength wastewater was investigated to simulate the domestic sewage which is a complex wastewater with high fraction of suspended solids (SS). volatile fatty acids (VFAs), COD, and pH from the EABR were monitored as a measure of reactor performance. The analyses of COD was carried out according to the standard methods for the analysis of water and wastewater described by the American Public Health Association. VFAs were measured using a Hewlett Packard (HP) 6890 FID system equipped with a refractive index detector. Samples were firstly centrifuged at 10,000 rpm for 5 minutes. Then, the samples were filtered through a 0.22μ cellulose acetate (CA) filter before GC analysis. The VFAs were analyzed using an Aminex HPX-87H column; the column temperature was 65° C., and 5 mM of H₂SO₄ was used as the eluent at a flow rate of 0.6 mL min.

The results at an initial influent contained COD of 600 mg/L indicated that COD removal was 92% and the VFAs were close to zero by the 3rd compartment. Also, VFA analysis showed that propionic acid was found in the first two compartments. This finding is aligned with compartment-wise profiles of COD removal which may be the highest in the initial compartments and decreased longitudinally down the reactor. The largest pH drop may be observed in the first two compartments due to acidogenesis and acetogenesis activities. The integration of controlled electrolysis could decrease the startup process time to 12 days for low-strength synthetic wastewater feed. A sustained pH can maintain the functionality of enriched community of bacteria through integration of bio-electrochemical process in anaerobic digestion, as well as the application of the potential strategies to optimize the start-up process of ABR.

Developing a high and stable contaminant-removal efficiency is a characteristic of ABR and reflects their competitiveness. The steps interval between doubling the COD amount (from very diluted amount to higher concentrations) decreased from 10 days in an ABR to 3 days in an EABR when using electrolysis and a controlled feedback loop to maintain the pH. This reduction in the acclamation time could be caused by the effect of electrolysis process. The pH level is a key parameter to the evolution performance of the anaerobic process. In AD systems, each microorganism group has different optimum pH values, but the most important microorganisms are methanogenesis.

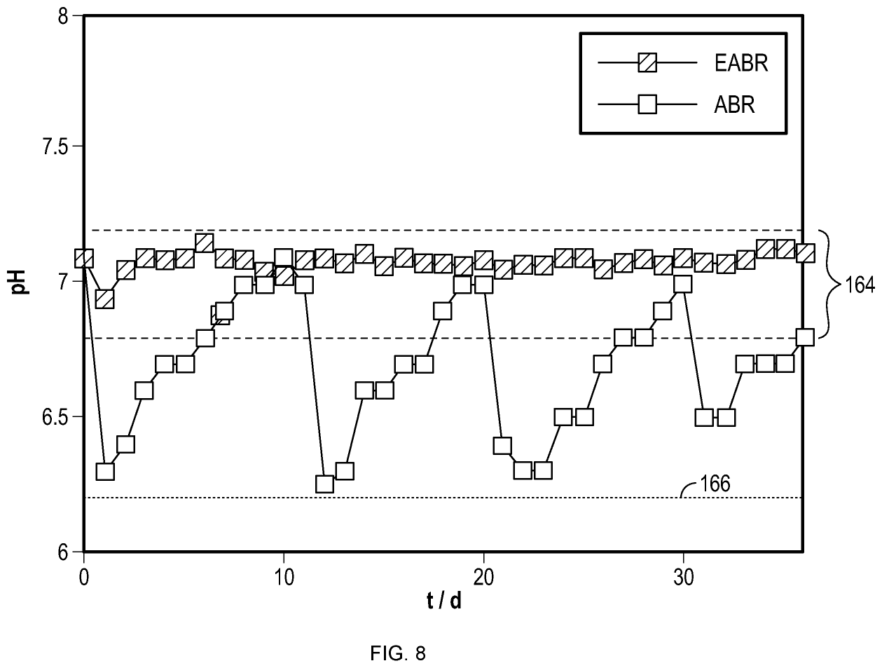

Methanogens are sensitive to changes in pH and the optimal pH range of methanogen activity is 6.8 to 7.2. As illustrated in FIG. 8, after inoculation of the reactor on day 1, the pH dropped but it was recovered shortly in the next day. The pH profile in the EABR and ABR for HRT=24 h. This profile shows the effectiveness of ER process in pH control and fast start-up simultaneously. The EABR control system is adjusted to maintain a pH value in the optimum function range 164 (6.8 to 7.2), while ensuring the no compartment falls below a minimum threshold 166, such as a pH value of 6.2.

This recovery is important due to the effectiveness of the electrolytic regeneration process in maintaining pH in the mentioned range. FIG. 8 also illustrates the pH profile of an ABR to make the comparison between pH revival using chemicals (NaOH) and ER feedback control system process. As shown in FIG. 8, using chemicals is more time consuming to reach a steady pH and produce required alkalinity while by using EC, the pH can be recovered in less time (3 d in EABR comparing to 10 d in ABR). In the conventional system, ABR, pellets of NaOH were added to the inlet of 106B at an approximate rate of 1.5 g_{NaOH}/L_{106B} every 4 hours to 6 hours to adjust the pH to the desired range (6.8 to 7.2) for the active methanogenesis in the anaerobic system. The addition of salts, such as NaOH, to AD to increase the alkalinity and pH can result in toxic accumulation of metal cations such as sodium in the bioreactor. Significant toxicity may be exhibited at concentrations above 1.5 g_{Na}+/L.

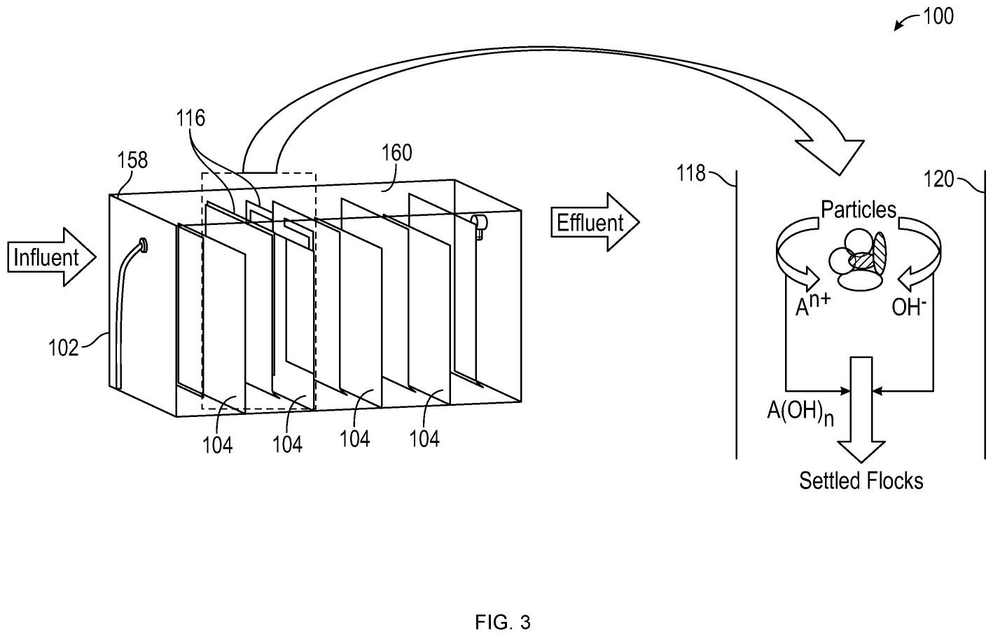

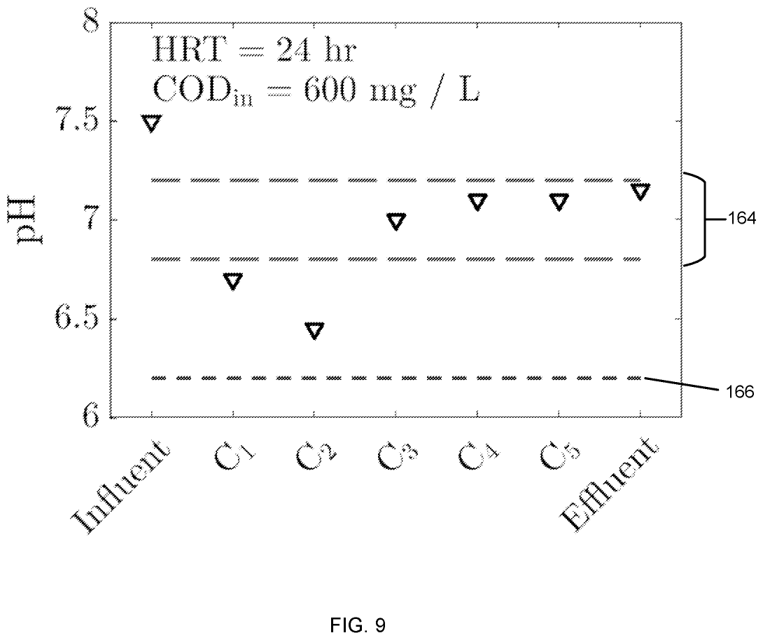

The ability of pH recovery of the EABR was shown in FIG. 3 at the CODᵢₙ=600 mg/L, which is the typical COD of domestic wastewater. The compartment-wise pH assessment exhibited that in the first compartments, 106A and 106B, presence of organic matter led to low pH value through fermentation process. As illustrated in FIG. 9 the pH was successfully maintained in the optimum range of what mentioned above for AD process in the EABR. After electrolytic regeneration process, the pH values increased down the reactor (near effluent point) due to the degradation of VFA in the later compartments. FIG. 9 shows the compartment-wise pH profile in the EABR for HRT=24 h. The system is adjusted to maintain a pH value in the optimum function range 164 while ensuring the no compartment falls below the minimum pH threshold 166. The minimum pH threshold may be 6.2. If pH deviates from the optimized pH range of methanogens, the methanogenic activity decreases. This condition leads to an accumulation of the acetogenesis end products which can be measured through a parameter related to alkalinity level and the amount of VFAs. In some aspects of the present disclosure, the alkalinity level and amount of VFA's may be inputs into the control system 122. The control system adjusts the pH which will affect the VFA and methanogenesis production. If the amount of VFA is too high, the control system 122 may increase or decrease the pH level by increase or decreasing the current or revival time. In the EABR, first, pH levels generally decreased due to the fatty acids accumulation by acidogenesis and acetogenesis at former compartments in the reactors. Then, pH level increased due to being consumed by fatty acids at the last compartments.

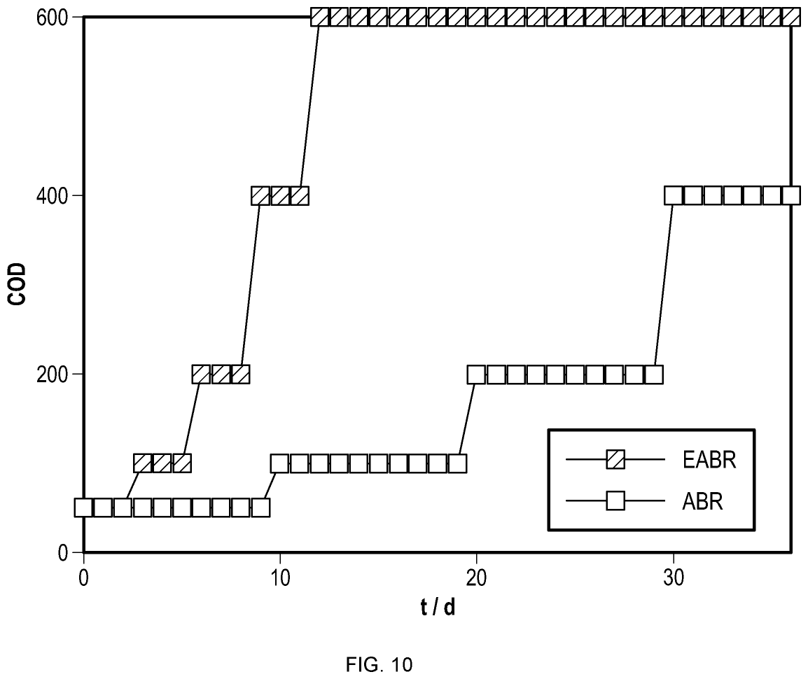

The increasing steps of COD in EABR and ABR with a stable pH are described in FIG. 10. In the ABR, NaOH was added to the inlet of 106B to adjust the pH to the desired range (6.8 to 7.2) for the active methanogenesis in the anaerobic system. The increasing levels of COD may explain the rapid jumps in pH of EABR and ABR.

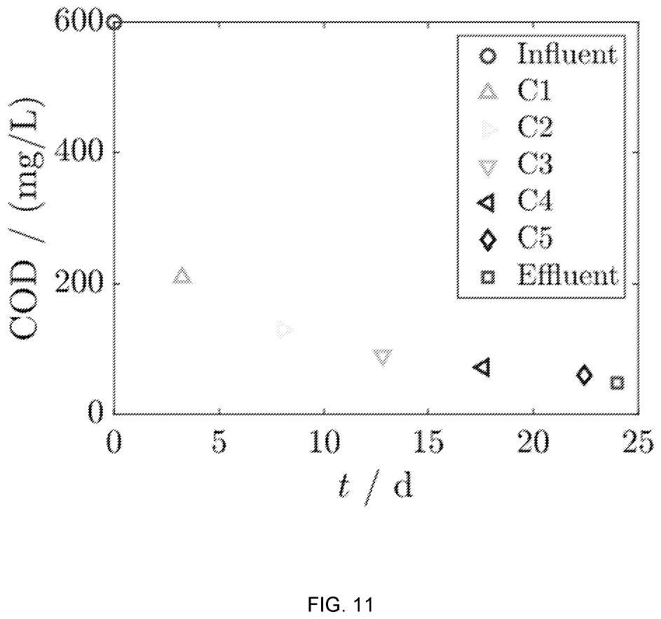

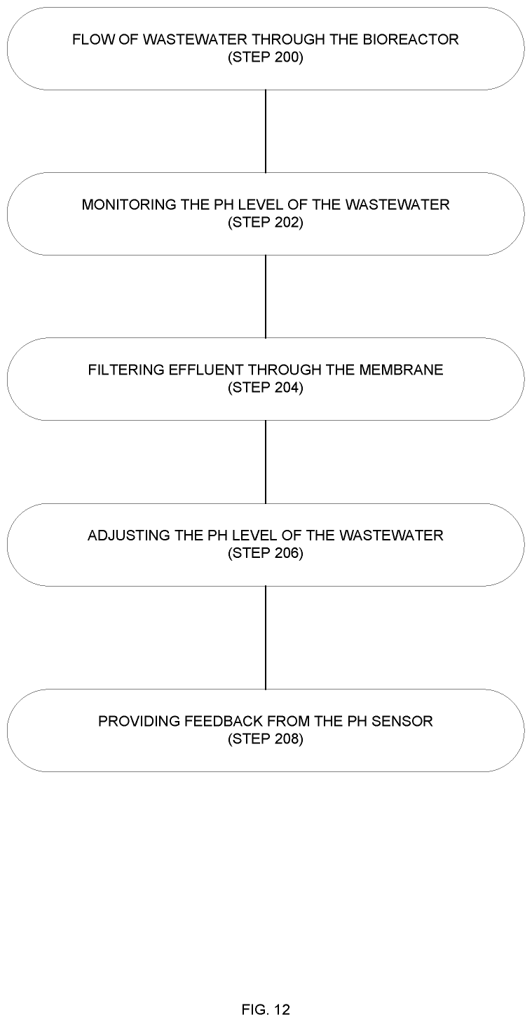

To determine the performance of the EABR, the compartment-wise COD and VFA changes were measured and reported. As illustrated in FIGS. 11 and 12 most of the COD removal efficiency occurred in the at least the first compartment 106A or at least the first two compartments, 106A and 106B. In some aspects of the present disclosure, the COD removal efficiency was 65% in 106A and 38% in 106B. Most of the organic matter may be removed in the first two compartments, as shown by the COD removal efficiency. FIG. 11 illustrates the compartment-wise COD profile in the EABR for HRT=24 hours and the CODin=600 mg/L. At the end of the 36-day operation, the electrodes were removed from the EABR and the operation in a common mode of ABR using chemicals for pH control was continued. Depending on the material of the electrodes, the surface of the electrodes may be corroded. This can be due to the emerging of H₂S and the effect of electrode material.

The pH of the wastewater treatment system may be controlled by electrolytic regeneration using electrolysis, as shown in FIG. 12. First, wastewater may enter the bioreactor from a feed tank and flow through the bioreactor (200). A plurality of microorganisms can break down the wastewater during acidification and methanogenesis to form an effluent and biogas. The pH of the wastewater may be monitored (202). The pH may be monitored by a pH sensor housed within the bioreactor. Effluent from the bioreactor may be filtered through a membrane to obtain permeate (204). The pH may be adjusted to enhance methanogenesis and filtration of the effluent (206). The pH may be adjusted through electrolysis and the regeneration of electrolytes. The pH may be adjusted if the pH sensor senses the pH has dropped and the microorganisms are no longer optimally breaking down the wastewater. The pH can also be adjusted if the temperature exceeds a certain threshold, or the level of TSS reaching the membrane is too high. Feedback may be provided from the pH sensor by a control system operatively connected to the bioreactor (208). The feedback can be provided in real time.

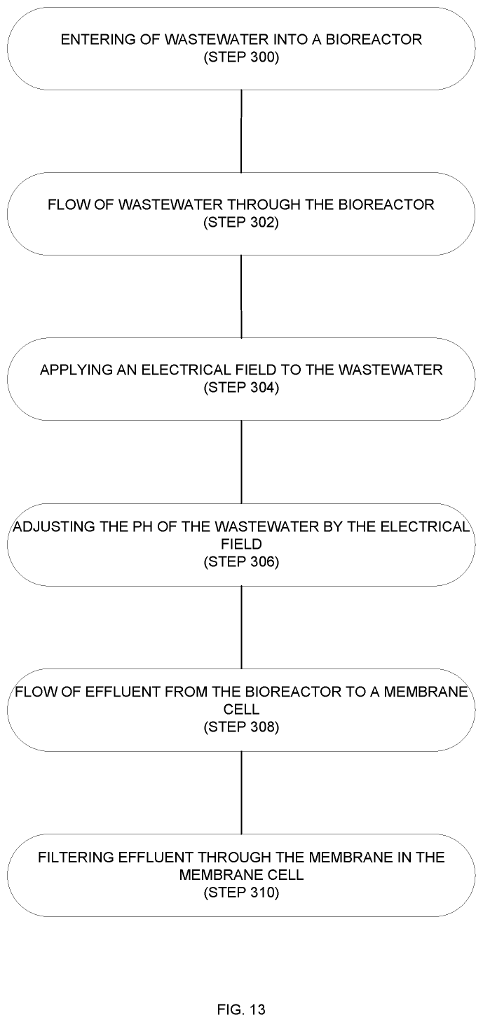

Another method for electrolyte regeneration to adjust the pH of a wastewater treatment system is shown in FIG. 13. The method may include wastewater entering the bioreactor through an inlet such as a feed tank (300). The wastewater may be grinded up prior to entering the bioreactor to decrease the size of any solids in the wastewater. Next, the wastewater may flow through the bioreactor (302). The wastewater may flow through a series of baffles directing the wastewater towards an outlet. The baffles may separate the bioreactor into a plurality of chambers, each chamber housing microorganisms for breaking down the wastewater into effluent. Next, an electrical field may be applied to an aqueous solution containing the wastewater by electrodes in the bioreactor (304). The electrodes may be housed in the second chamber of the bioreactor where acidogenesis is occurring. Next, the pH may be adjusted by the electrical field applied (306). The pH may be adjusted to an optimal range for methanogenesis to start or continue. Next, effluent may leave the bioreactor and enter the membrane cell (308). Lastly, the effluent may be filtered through the membrane to become permeate (310).

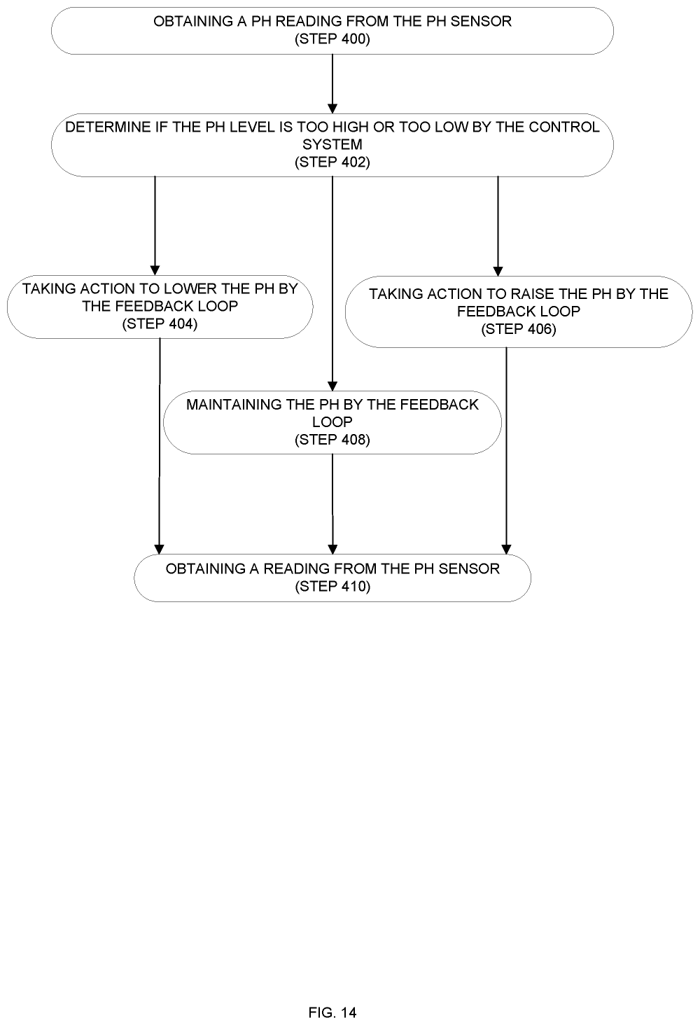

The feedback loop 122 may contain parameters to determine if the pH needs to be raised or lower, as shown in FIG. 14. First, the pH sensor takes a pH reading (Step 400). Then the control system determines if the pH reading is too high or too low (Step 402). If the pH is low, the feedback loop takes action, such as stopping a current to lower pH or shutting the feedback loop off, allowing alkalinity to be consumed by the bioreactor 102, to lower the pH (Step 404). If the pH is too low the feedback loop may start or increase a current to raise the pH, increasing the alkalinity in the bioreactor 102 (Step 406). If the pH is within a certain threshold the feedback loop maintains its current activity (Step 408), this may be running a current, running a current for certain intervals, or not running a current through the electrodes. Lastly, after a certain amount of time, the pH sensor takes another reading (Step 410) and the process restarts.

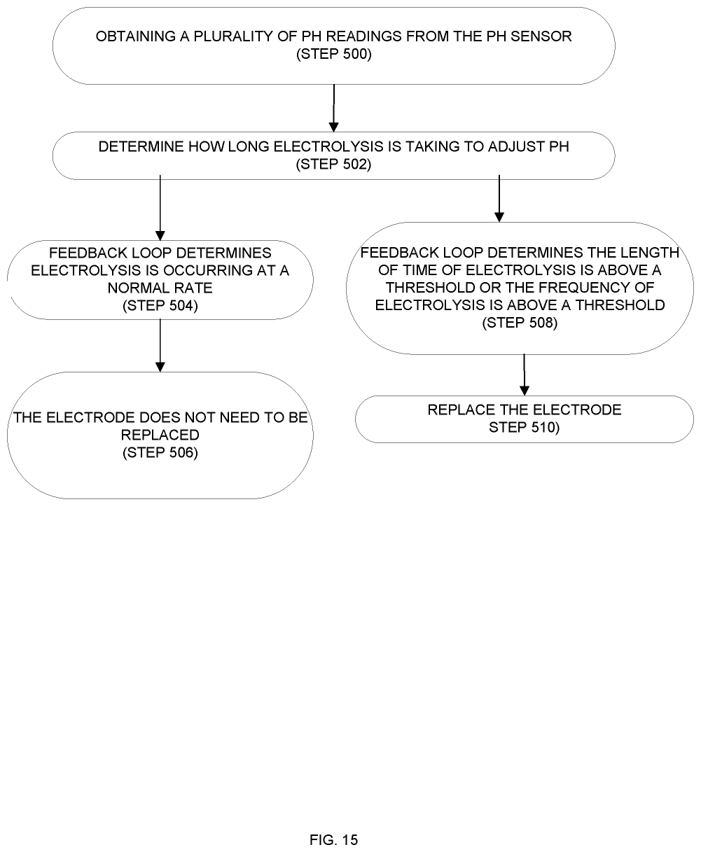

The feedback loop 122 may contain parameters to determine if the electrode material is corroding and needs to be replaced to maintain efficiency of the wastewater treatment, as shown in FIG. 15. The electrode status can be determined by the effluent quality leaving the bioreactor, the pH levels, the amount of time it takes to adjust the pH, the number of times the pH has to be adjusted during a given time frame, the microbial activity levels, or any other factors. For example, first the feedback loop 122 may obtain a plurality of pH readings from the pH sensor (Step 500). Next, the feedback loop determines how long electrolysis is taking to adjust the pH (Step 502). The feedback loop determines electrolysis is occurring at a normal rate (Step 504). The electrode does not need to be replaced (Step 506). The feedback loop may determine that the length of time of electrolysis is above a threshold or the frequency of electrolysis is above a threshold (Step 508), then the electrode is replaced (Step 510). The feedback loop 122 may provide an alert if the electrodes appear to be corroding letting a user of the wastewater treatment system know that the electrodes need to be replaced. For example, if electrolysis is being performed for a longer period or is needed more often to maintain a stable pH, the feedback loop 122 may determine that the electrode is corroding and send an alert that a replacement is needed or that a user has a certain amount of time before a replacement is needed.

The wastewater treatment system the EABR was able to treat low-strength wastewater successfully. The COD removal efficiency at 24 h HRT was 92%. The reduction in organic matter (COD) was achieved mainly in the first few compartments. VFA profiles may indicate that compartmentalization in EABR serves to separate acidogenic and methanogenic activities longitudinally through the reactor similar to common ABR, with the highest portion of acidogenic activity happening in the first compartment. Employing EC may help to recover pH while break down the COD and VFA. Moreover, the time of the start-up stage of the EABR decreased from what has been reported in the literature to be at least 80 days to less than a month for low-strength wastewater which will facilitate the application of AD processes in the domestic wastewater treatment.

The disclosure is not to be limited to the particular aspects described herein. In particular, the disclosure contemplates numerous variations in electrolyte regeneration and pH adjustment in anaerobic membrane bioreactors. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes, or methods of the disclosure. It is understood that any other modifications, substitutions, and/or additions can be made, which are within the intended spirit and scope of the disclosure.

What is claimed is:

1. An anaerobic bioreactor with electrolytic regeneration for wastewater treatment, the anaerobic bioreactor comprising:
an anaerobic bioreactor having a longitudinal wall, wherein in the longitudinal wall is divided into a plurality of chambers and wherein anaerobic bacteria are housed within the plurality of chambers, the anaerobic bioreactor further comprising:
at least one pair of electrodes, wherein the pair of electrodes further comprise an anode and a cathode, and wherein the pair of electrodes are configured to adjust a pH level of wastewater in the bioreactor;
wherein the pair of electrodes regenerate electrolytes;
a pH sensor operatively connected to the bioreactor for sensing the pH level of the wastewater;
a discharge mechanism for carrying effluent from the anaerobic bioreactor to a membrane cell;
the membrane cell comprising a nanocomposite membrane for filtering effluent produced by the anerobic bioreactor; and
wherein the pair of electrodes reduce an amount of total suspended solids discharged from the bioreactor to the membrane cell;
a pH control system wherein the pH control system is configured to adjust the pH if the level exceeds a threshold.

2. The anaerobic bioreactor system of claim 1, wherein the electrodes reduce the chemical oxygen demand.

3. The anaerobic bioreactor system of claim 1, further comprising at least one temperature sensor operatively connected to the anerobic bioreactor for monitoring a temperature of the wastewater.

4. The anaerobic bioreactor system of claim 1, wherein the pair of electrodes is housed in a second chamber of the plurality of chambers.

5. The anaerobic bioreactor system of claim 1, wherein the electrodes reduce an amount of total suspended solids reaching the membrane.

6. The anaerobic bioreactor system of claim 1, further comprising a heating tank for adjusting the temperature of the anaerobic bioreactor.

7. The anaerobic bioreactor system of claim 1, wherein the membrane is a nanocomposite membrane.

8. A wastewater treatment system for controlling a pH of an anaerobic membrane bioreactor, the control system comprising:
a bioreactor housing a pH sensor, wherein the pH sensor monitors a pH level of wastewater in the bioreactor, wherein the wastewater further comprises wastewater flowing through the bioreactor;
wherein the bioreactor houses a plurality of microorganisms for breaking down the wastewater prior to the wastewater reaching a membrane cell;
a pH adjuster operatively connected to the bioreactor and a control system, wherein the pH adjuster is configured to adjust the pH if the pH level exceeds a threshold; and
the control system further comprising a processor, wherein the control system analyzes the pH of the bioreactor utilizing data sensed by the pH sensor, wherein the control system is configured to adjust the pH utilizing electrolysis if the pH level exceeds a threshold.

9. The wastewater treatment system of claim 8, further comprising:
a temperature sensor operatively connected to the control system and the bioreactor for sensing the temperature of wastewater in the bioreactor.

10. The wastewater treatment system of claim 8, further comprising:
at least a pair of electrodes housed within the bioreactor, wherein the pair of electrodes are configured to adjust the pH by applying a voltage and wherein the electrodes adjust the pH before methanogenesis.

11. The wastewater treatment system of claim 8, wherein the control system provides real-time feedback from a plurality of sensor inputs.

12. The wastewater treatment system of claim 8, wherein the control system is configured to adjust the pH if the control system determines that an amount of total suspended solids reaching a membrane cell of the anaerobic bioreactor exceeds a threshold.

13. The wastewater treatment system of claim 8, wherein the pH adjustor applies a voltage to a pair of electrodes to adjust the pH.

14. The wastewater treatment system of claim 13, wherein the pair of electrodes regenerate electrolytes configured to adjust the pH of the wastewater.

15. A method for controlling the pH of an anaerobic membrane bioreactor with electrolytic regeneration:
flowing wastewater through a bioreactor, wherein a plurality of microorganisms breaks down the wastewater during acidification and methanogenesis to form an effluent;
monitoring a pH of the wastewater in the bioreactor by a pH sensor housed within the bioreactor;
filtering effluent through a membrane to obtain permeate; and
adjusting the pH of wastewater in the bioreactor to enhance methanogenesis and filtration of the effluent, wherein the adjusting of the pH comprises electrolysis.

16. The method of claim 15, wherein the bioreactor houses at least a pair of electrodes within the bioreactor and wherein the at least one pair of electrodes is configured to adjust the pH.

17. The method of claim 16, wherein the bioreactor has at least five chambers, wherein the at least one pair of electrodes is housed in a second chamber of the at least five chambers.

18. The method of claim 15, further comprising:
providing feedback from the pH sensor by a control system operatively connected to the bioreactor.

19. The method of claim 15, wherein the effluent comprises flux and wherein the pH is adjusted if an amount of total suspended solids reaching the membrane exceeds a threshold.

20. The method of claim 15, wherein the adjusting the pH further comprises turning a voltage of a pair of electrodes housed within the bioreactor on or off to generate electrolytes.
